(19) United States
(12) Patent Application Publication
(10) Pub. No.: US 2018/0228140 A1
(43) Pub. Date: Aug. 16, 2018

(54) Out Only Rodent Blocker

(71) Applicant: Chester F. Lelio, Lincoln, CA (US)

(72) Inventor: Chester F. Lelio, Lincoln, CA (US)

(21) Appl. No.: 15/433,772

(22) Filed: Feb. 15, 2017

(51) Int. Cl. A01M 29/30

(52) U.S. Cl. CPC A01M 29/30

(57) ABSTRACT

Under the classification of Rat Traps, this invention is a unique blocker of voles, moles, gophers and small animals from reentering the security of their nests after exiting to attain food and water. The invention consists of a platform with hooks or prongs and a wire bracket, flags and a spike. Placement of the platform totally within the rodent's primary and secondary passageways utilizes the firmness of the soil to contain the rodents as they venture “Out but not In!”. Green Communities will welcome the predator friendly aspects of this device of “No poisons, No bait, No messy dead bodies!” Worldwide acceptance of this invention is possible due to its being simple, easy, low cost, durable and efficient.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

The field of animal traps centers primarily upon the movement, capture and disposition of the animals that are bothersome to the public and differ greatly in their cost and overall effectiveness. Few, if any traps focus their efforts upon the total placement of their devices under the ground effortlessly while attaining the elimination of the animals thru blockage alone, with no rodent's dead bodies to dispose of. The low cost, high rate of effectiveness and lasting durability of this invention will challenge today a highly competitive field of rodent controls.

When comparisons are made to the Kelley U.S. Pat. No. 4,538,375 and Donoho US 2014/0041318 patents this invention is amazingly different: Kelley's device is expensive to manufacture (with welded sections, hinges, loops, eyes and snaps) and an elongated tapered 2 or 3 section body, wire cones that direct rodents into a cage, is cumbersome and difficult to remove live or dead rodent's from the cage where my invention has no cage to empty. Kelley has a spike placed vertically in the middle of the cone reducing the size of the rodents to smaller ones only, or, a larger trap as being necessary to handle larger rodents. and a limitation on mounting the trap to the front of the entrance to the primary hole only and not into the smaller secondary rodent's hole that is only 1½″-2″ wide and being multi-directional which can be easily avoided by the exiting/entering rodents. Kelley is a wired cage, or trap, without an exit that has an entrance only into the device to contain rodents and cannot claim movement exiting or entering the entire device, as the OORB claims; the rodent's movement out of the nest to be eaten by predators is the paramount function of the OORB and is not possible in the Kelley device. Kelley's is a wired, tapered coned body that claims to be placed in the rodent's hole with the majority of the device outside the hole. Several issues are of concern: first, the primary hole is always lying horizontally that would be difficult to insert this device inwards and upwards, since the wired basket must bend over to lie flat on the ground to catch the rodent for disposal by the homeowner and would eventually “close the cone” over a period of time making the device useless. Secondly, the second hole leading into the rodent's nest points in one of four directions: left, right, straight and downwards giving the device only a 25% chance of successfully of the rodent entering the device. Conversely, the OORB's success rate is always 100% because the homeowner first inserts his finger, or device, into the primary hole and within 2″ will detect the direction of the inner hole and will continue placing the remaining 3″ of the OORB into this hole. The rodent will now slide outwards easily from the nest because the walls of his nest are made of soil that he created instead of hard wire walls of the Kelley device that have been crimped into his passageway.

When comparisons are made with Donoho's patent we find that it is made for a bird's ledge/opening that has lots of sharp point's to stop bird's entry on a building's ledge and has only one function; as a stopper for birds. Perhaps this device could be utilized for other animals, in other situations, but not in the case of the OORB's wire bracket having two functions; allowing the rodent to proceed easily and as a blocker upon reentry. The patent examiner makes reference to Donoho's device being attached to the rear of Kelley's device which is not possible because his container/cage for disposing of rodents has no exiting hole for the Donoho device to attach to and function properly. The OORB'S wire bracket has two main functions to allow rodents to exit their nest freely, as well as, hindering their reentry into the nest by simulating the bite of a gopher snake.

### BRIEF SUMMARY OF THE INVENTION

This invention is simple to operate, durable, inexpensive and unique in its functioning totally within the passageways and nests of vols, moles and gophers as a blocker_not as a trap. The rodents are allowed to freely exit their nests, but are unable to reenter due to the home owners progressively moving of the devices towards active holes and they are eliminated by their natural predators or leave the area.

### BRIEF DESCRIPTION OF THE SEVERAL VIEWS OF THE DRAWINGS

FIG. 1 Side View of the Out Only Rodent Blocker

FIG. 2 Top View of the Out Only Rodent Blocker

FIG. 3 Side View of the Flag (White)

FIG. 4 Side View of the Flag (Brown)

FIG. 5 Side View of the Spike

### DETAILED DESCRIPTION OF THE INVENTION

The invention includes a platform 1 with two treble hooks (or prongs) 2, a wire bracket (or prongs) 3, mounted on a board with two screws and a drilled hole for a spike (metal, plastic or composite) 4. This portion of the invention will be placed in a rodent's hole that has been determined to be currently in daily use by rodents to venture out of their hole to obtain food and water. Prior to placing the platform into the larger primary hole the homeowner will place their finger into the hole to determine which direction the secondary hole to the nest has been formed by the rodent. The secondary hole is smaller than the primary hole and the platform must be horizontally placed on the floor within this hole.

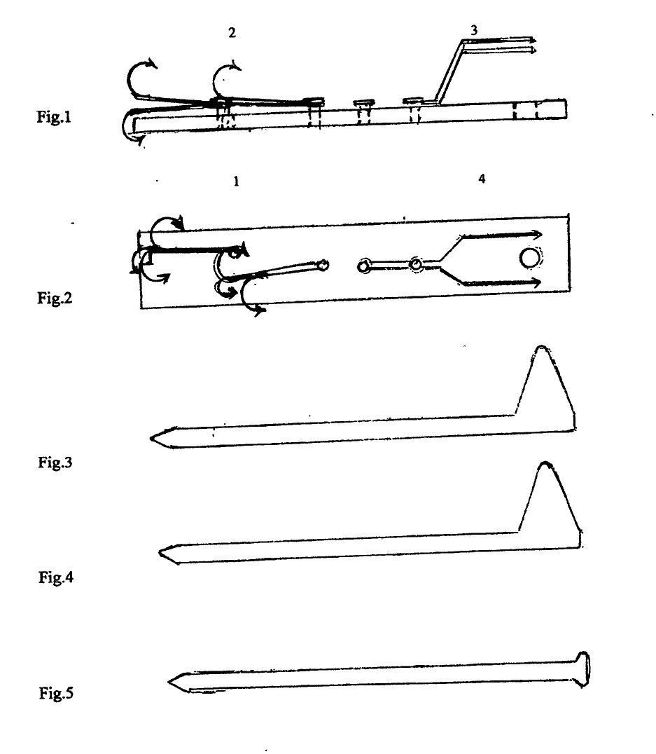

Next, the spike FIG. 5 must be placed in the platform and firmly into the soil at the rodent's opening to secure the platform and a white flag FIG. 1 placed in the soil to secure the location of the platform after the soil has been placed over the platform. After a 24/48 hour period of time has expired, the entire area is checked for any activity by rodents near the white flag holes and soil is added to cover up any newly disturbed holes. Another 24 hour waiting period. If a white flagged hole has not been disturbed in a 2-3 day period the devices and their white flag are relocated to a newly activated hole and a brown flag FIG. 4 to be placed at this hole. Over a period of days, a visual pattern of brown and white flags will appear over the entire area until the white flags are totally replaced by brown flags indicating a total absence of rodents at this site.

The hooks or prongs are attached from the front of the platform in a notch and from the top of the platform with two screws and both hooks point outwards to the end of the device. The middle hook's point overlaps the the end hook's screw thereby securing both hooks at this point. The number of hooks or prongs can vary upwards or downwards depending upon the size of the rodents and the conditions of the site. Gravity will drive the rodents down into the points of the hooks or prongs.

The wire bracket is secured with two screws and two washers and faces outwards to the entrance of the rodent's nest. The rodents can slide easily over the wire bracket as they exit the passageway, but will encounter the sharp points of the wire bracket upon their attempt to reenter the nest. The two points of the device is ¾″ in height from the platform's base and will prick the returning rodent's in the face emulating a striking gopher snake's bite. The wire bracket is made of stainless steel to maintain its firmness and durability but can be replaced with plastic or composite materials.

### SEQUENCE LISTING

| | | |
|---|---|---|
| U.S. Pat. No. 4,538,375 | September 1985 | Kelley, Benton B. |
| U.S. Pat. No. 5,185,415 | February 1993 | Hattenbach |
| U.S. Pat. No. 4,538,375 | September 1985 | Kelley |
| U.S. Pat. No. 4,489,516 | December 1984 | Moorhead |
| U.S. Pat. No. 4,449,316 | May 1984 | Moorhead |
| U.S. Pat. No. 4,370,823 | March 1980 | Moorhead |
| US-20140041318-A1 | February 2014 | Donoho |

1. I claim an animal trap for voles, moles and gophers that includes five components that are interrelated in their functions comprising of a platform with treble hooks, or prongs, that allow egress from a rodent's nest, but restricts reentry due to gravity and multiple sharp points and a wire bracket with sharp points pointing out to egress, that will emulate a gopher snake's bite as a further deterrent and multicolored flags denoting location and movement of the rodents land a non-corrosive spike that all together establish a progressive evacuation of the rodent's nest.

2. A method for eliminating rodents, or pests, from their nests including the step of placing the device of step 1: a device will be first inserted into the larger primary hole at the entrance to the nest to determine which direction the secondary hole is going towards the nest by placing an object into the hole to determine whether this hole is going left, right, straight or downwards towards the rodent's nest for the device to be effective.

3. Per claim 1, each flag will receive either a white flag to denote an active hole, or a brown flag indicating a vacated hole visually indicating the status of the rodent's hole and their progression in their either being eliminated, or their abandonment of the est.

4. a rodent blocker, comprising a combination:
A rigid underlying platform of elongate form between a pair of ends, including a front blade end and a rear end, and a pair of opposing sides, and with a top surface opposite a bottom surface.
At least one hook attached to said platform with a pointed prong of said at least one hook pointing toward a front end of said platform and elevated above said top surface of said platform;
a wire bracket including two prongs attached to said platform, said prongs of said wire bracket located closer to said front end than said hook, with said prongs of said wire bracket pointing toward said front of said platform.

5. the rodent blocker of claim 4 wherein said at least to allow hook includes a treble hook with three prongs each pointing toward said front and of said platform.

6. the rodent blocker of claim 5 wherein said prongs of said wire bracket and said prongs of said at least one treble hook are spaced from each other sufficient to allow a rodent to pass beyond said prongs with the rodent moving toward the front end of the platform.
